(19) United States
(12) Patent Application Publication
(10) Pub. No.: US 2011/0176865 A1
(43) Pub. Date: Jul. 21, 2011

(54) CAM-BOLT ASSEMBLY

(75) Inventors: Douglas D. Colby, Clarkston, MI (US); Bryan D. Spicer, Monroe, MI (US)

(73) Assignee: Q.E.D. ENVIRONMENTAL SYSTEMS, INC., Ann Arbor, MI (US)

(21) Appl. No.: 12/691,238

(22) Filed: Jan. 21, 2010

(51) Int. Cl. F16B 21/00

(52) U.S. Cl. 403/324

(57) ABSTRACT

A cam-bolt assembly includes a latch handle having a cam portion having first and second cam arms. A hinge pin slides through an aperture created through the cam arms and includes a threaded aperture. A clamp rod has a threaded portion engaged with the threaded aperture and opposed washer engagement flats each having a pin receiving bore aligned perpendicular to the flats. A pivot washer is rotatably connected by a pivot pin received through the pin receiving bore and is rotatable from a first position having the pivot washer coaxially aligned with a clamp rod longitudinal axis to a second position transverse to the first position. The pivot washer rotates from the first to the second position in either a clockwise or counterclockwise direction. The pivot washer is retained in the second position by horizontal displacement in a direction transverse to the clamp rod longitudinal axis after rotation.

### FIELD

The present disclosure relates to clamping devices used to releasably couple two or more components together.

### BACKGROUND

This section provides background information related to the present disclosure which is not necessarily prior art.

Clamping devices can provide a rotatable handle having a pin rotatably connecting the handle to a shaft of a locking device. The locking device is positioned in contact with one or more members to be held in clamped engagement. Rotation of the handle alone is thereafter all that is required to longitudinally displace the locking device inducing a clamping force to provide the clamped engagement, and an opposite rotation of the handle can release the clamping force. These clamping devices therefore provide for one-hand clamping operation and do not require a further tool such as a wrench to hold the locking device while the handle is rotated.

### SUMMARY

This section provides a general summary of the disclosure, and is not a comprehensive disclosure of its full scope or all of its features.

According to several embodiments, a cam-bolt assembly includes a latch handle having a cam portion including spatially separated first and second cam arms. A hinge pin is slidably disposed through a hinge pin aperture created in both the first and second cam arms, the hinge pin including a threaded aperture. A clamp rod has at a first end a threaded portion threadably engaged with the threaded aperture of the hinge pin, and at a second end opposed washer engagement flats having a pin receiving bore created through and aligned perpendicular to the washer engagement flats. A pivot washer is rotatably connected at the second end by a pivot pin received through the pin receiving bore. The pivot washer is rotatable from a first position having the pivot washer coaxially aligned with a longitudinal axis of the clamp rod to a second position rotated ninety degrees from the first position. The pivot washer is rotatable from the first position to the second position by rotation in either a clockwise or counterclockwise direction. The pivot washer is releasably retained in the second position by subsequent horizontal displacement in a direction transverse to the longitudinal axis of the clamp rod after rotation in either the clockwise or counterclockwise direction.

According to other embodiments, a cam-bolt assembly includes a latch handle having a cam portion including first and second cam arms separated by an arm spacing cavity. A hinge pin is slidably disposed through a hinge pin aperture created in both the first and second cam arms, the hinge pin including a threaded aperture. A clamp rod has a first end connected to the hinge pin and a second end including opposed washer engagement flats having a pin receiving bore created therethrough. A pivot washer includes spatially separated first and second washer arms each having an elongated aperture. The pivot washer is rotatably connected at the second end of the clamp rod by a pivot pin received through the elongated apertures of the first and second washer arms and the pin receiving bore. The pivot washer is rotatable from a first position having the pivot washer coaxially aligned with a longitudinal axis of the clamp rod to a second position rotated ninety degrees from the first position. The pivot washer is rotatable from the first position to the second position in either a clockwise or a counterclockwise direction. The pivot washer is releasably retained in the second position by subsequent horizontal displacement in a direction transverse to the longitudinal axis of the clamp rod having the pivot pin positioned toward either a first or a second end of the elongated aperture such that the pivot pin is positioned away from a central axis of the pivot washer.

According to still other embodiments, a cam-bolt assembly for connecting multiple flanges includes a clamp rod having a first end connected to a hinge pin and a second end including opposed washer engagement flats having a pin receiving bore created therethrough. A pivot washer has a connecting end with spatially separated first and second washer arms each having an elongated aperture extending from the connecting end. The pivot washer is rotatably connected at the second end of the clamp rod by a pivot pin received through the elongated apertures of the first and second washer arms and the pin receiving bore. The pivot washer is rotatable from a first position having the pivot washer coaxially aligned with a longitudinal axis of the clamp rod to a second position rotated ninety degrees from the first position. The pivot washer is rotatable from the first position to the second position in either a clockwise or a counterclockwise direction. At least one pivot washer raised portion extends away from a planar surface of each of the first and second washer arms and the connecting end, the at least one pivot washer raised portion defining a raised portion diameter. When the pivot washer is rotated to the second position the at least one pivot washer raised portion is aligned within a fastener receiving aperture of one of the multiple flanges, the raised portion diameter defining a sliding fit within the fastener receiving aperture to minimize horizontal deflection of the clamp rod.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front right perspective view of a cam-bolt assembly of the present disclosure;

FIG. 2 is an assembly drawing of the cam-bolt assembly of FIG. 1;

FIG. 3 is a front perspective view of a latch handle for the cam-bolt assembly of FIG. 1;

FIG. 4 is a top plan view of the latch handle of FIG. 3;

FIG. 5 is a front elevational view of the latch handle of FIG. 3;

FIG. 6 is an end elevational view of the latch handle of FIG. 3;

FIG. 7 is a front perspective view of a hinge pin for the cam-bolt assembly of FIG. 1;

FIG. 8 is a side elevational view of the hinge pin of FIG. 7;

FIG. 9 is a front elevational view of the hinge pin of FIG. 7;

FIG. 10 is a top plan view of the hinge pin of FIG. 7;

FIG. 11 is a front perspective view of a clamp rod of the cam-bolt assembly of FIG. 1;

FIG. 12 is a side elevational view of the clamp rod of FIG. 11;

FIG. 13 is a front elevational view of the clamp rod of FIG. 11;

FIG. 14 is a front perspective view of a clamp washer of the cam-bolt assembly of FIG. 1;

FIG. 15 is a front elevational view of the clamp washer of FIG. 14;

FIG. 16 is a side elevational view of the clamp washer of FIG. 14;

FIG. 17 is a front right perspective view of a pivot washer of the cam-bolt assembly of FIG. 1;

FIG. 18 is a top plan view of the pivot washer of FIG. 17;

FIG. 19 is a front elevational view of the pivot washer of FIG. 17;

FIG. 20 is an end elevational view of the pivot washer of FIG. 17;

FIG. 21 is a cross sectional elevational view of a cam-bolt assembly of the present disclosure shown in a release position with respect to a flange installation;

FIG. 22 is a cross sectional elevational view of the cam-bolt assembly of FIG. 21 shown in a pivot washer clearance position;

FIG. 23 is a cross sectional elevational view of the cam-bolt assembly of FIG. 21 shown in a fully engaged position;

FIG. 24 is a cross sectional elevational view of the cam-bolt assembly of FIG. 21 shown in an over-center engaged position;

FIG. 25 is a front perspective view of a system flange showing the positioning of four cam-bolt assemblies of the present disclosure;

FIG. 26 is a front perspective view of a clamp rod portion of another embodiment of the cam-bolt assembly of the present disclosure; and

FIG. 27 is a front perspective view of a threaded rod for engagement with the clamp rod portion of FIG. 26.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

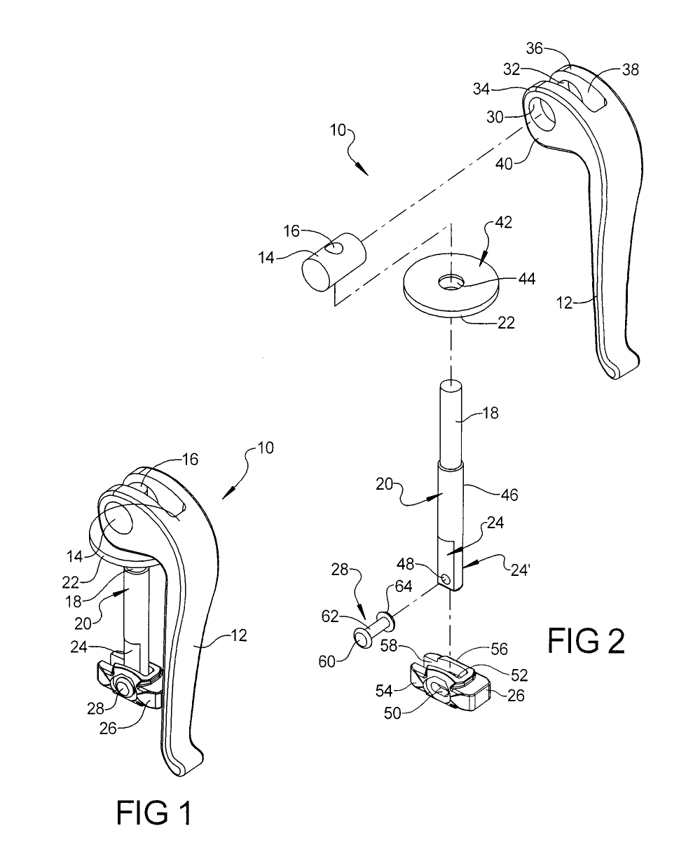

Referring to FIG. 1, a cam-bolt assembly 10 includes a latch handle 12 having a hinge pin 14 slidably disposed therethrough. A threaded aperture 16 of the hinge pin 14 threadably receives a threaded portion 18 of a clamp rod 20. A clamp washer 22 is positioned as shown to contact the latch handle 12 when slid to an end of clamp rod 20. Substantially parallel and opposed washer engagement flats 24, 24′ are created at an opposite end of the clamp rod 20 from the threaded portion 18. A pivot washer 26 is rotatably connected at the opposed washer engagement flats 24 using a connecting pin 28 such as a fastener, deformable pin, bolt or rivet.

Referring to FIG. 2, hinge pin 14 is rotatably and slidably disposed through each of a first and second hinge pin aperture 30, 32 created in opposed first and second cam arms 34, 36 of latch handle 12. First and second cam arms 34, 36 are separated by an arm spacing cavity 38 which provides clearance for clamp rod 20 to rotate and threadingly displace. Each of the first and second cam arms 34, 36 of latch handle 12 further include a cam portion 40 which frictionally directly contacts a cam portion contact surface 42 of clamp washer 22. Cam portion 40 according to several embodiments includes a non-circular or obround outer surface shape so that rotation of latch handle 12 displaces clamp washer 22 axially with respect to clamp rod 20. A clamp rod clearance bore 44 is created through clamp washer 22 which is provided to slidably receive the threaded portion 18 of clamp rod 20.

Clamp rod 20 further includes an un-threaded rod portion 46 which includes each of the washer engagement flats 24, 24′. A pin receiving bore 48 is created through un-threaded rod portion 46 and is oriented substantially perpendicular to each of the washer engagement flats 24, 24′. Connecting pin 28 as described in reference to FIG. 1 is received through pin receiving bore 48.

Pivot washer 26 includes first and second elongated apertures 50, 52 created in each of a first and second washer arm 54, 56, respectively. First and second washer arms 54, 56 are separated by a washer arm spacing cavity 58. A spacing or dimension between the first and second washer arms 54, 56 is selected to slidably receive washer engagement flats 24, 24′ of un-threaded rod portion 46. Pivot washer 26 is rotatably connected to clamp rod 20 by sliding connecting pin 28 through first elongated aperture 50, pin receiving bore 48, and second elongated aperature 52 such that a pin head 60 is positioned proximate to and outside of first elongated aperture 50 while a pin shaft 62 extends through each of the first and second elongated apertures 50, 52 and pin receiving bore 48. A pin peened, upset or rolled end 64 is created after pin shaft 62 is received through each of the elongated apertures such that pin end 64 rotatably and freely contacts washer second washer arm 56 while pin head 60 rotatably and freely contacts first washer arm 54 to permanently and rotatably connect pivot washer 26 to clamp rod 20. According to other embodiments, a releasable connection can also be provided for connecting pin 28.

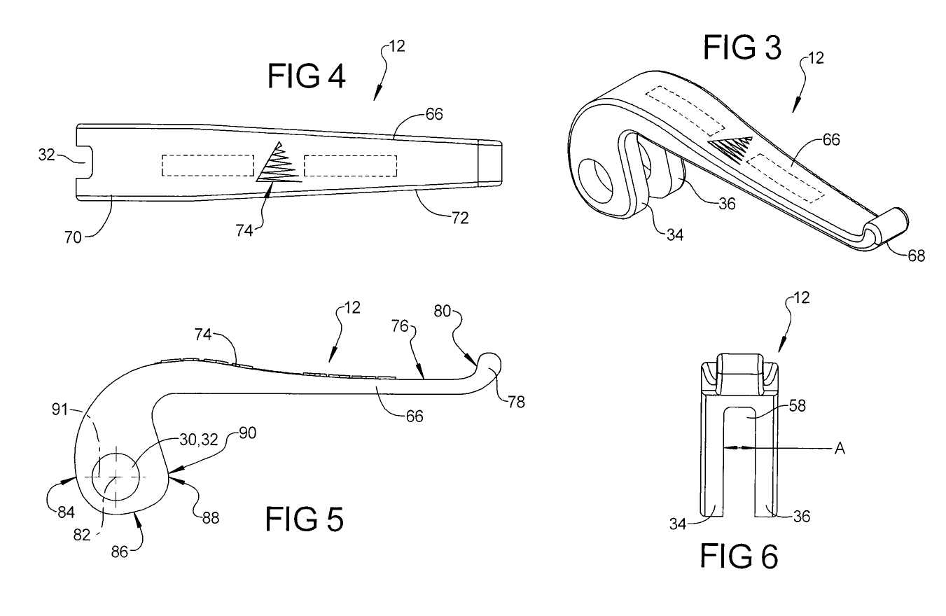

Referring to FIG. 3, latch handle 12 further includes a handle arm 66 extending freely away from first and second cam arms 34, 36. A handle knob 68 extending substantially transverse to handle arm 66 can be created at a free end of handle arm 66. Handle knobs 68 can provide a hold or contact point acting as a gripping surface to assist manual rotation of latch handle 12. According to several embodiments, latch handle 12 can be of a cast or forged metal, or a molded component.

Referring to FIG. 4, latch handle 12 further includes a handle first end 70 and an opposed handle second end 72. According to several embodiments, handle first end 70 is wider than handle second end 72 to provide for the spacing distance between first and second cam arms 34, 36. A plurality of raised symbols 74 can also be provided on an outer surface of handle arm 66 which are created during the manufacturing process of latch handle 12. The purpose of raised symbols 74 in addition to providing identification of the manufacturer of cam-bolt assembly 10 is to increase frictional contact during manual rotation of latch handle 12.

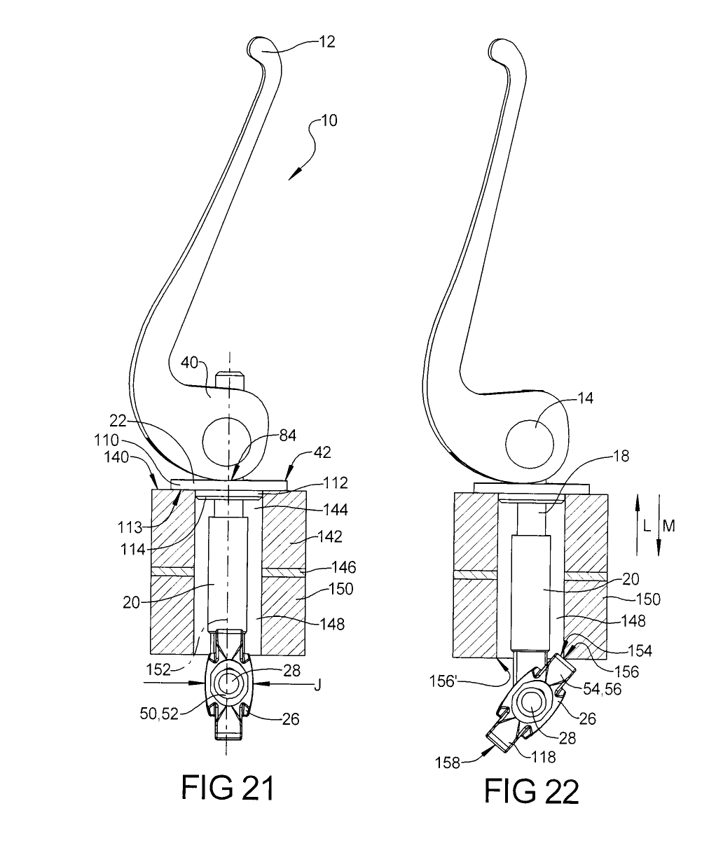

Referring to FIG. 5 and again to FIG. 3, raised symbols 74 which can be in the form of numbers, letters, or other identifying indicia are raised above a handle outer surface 76 of handle arm 66. According to several embodiments, handle knob 68 can also be created in the form of a handle knob 78 having a concave surface 80 connecting handle knob 78 to handle arm 66. Each of the first and second hinge pin apertures 30, 32 are coaxially aligned on a hinge pin longitudinal axis 82. The cam portion 40 of each of the first and second cam arms 34, 36 includes a release cam location 84, a camming surface 86, a maximum camming location 88, and an over-center camming location 90. These features will be further described in reference to FIGS. 21 through 24.

Referring to FIG. 6, a cavity width “A” between the first and second cam arms 34, 36 is maintained throughout a length of each of the first and second cam arms 34, 36. This provides a uniform spacing throughout the washer arm spacing cavity 58.

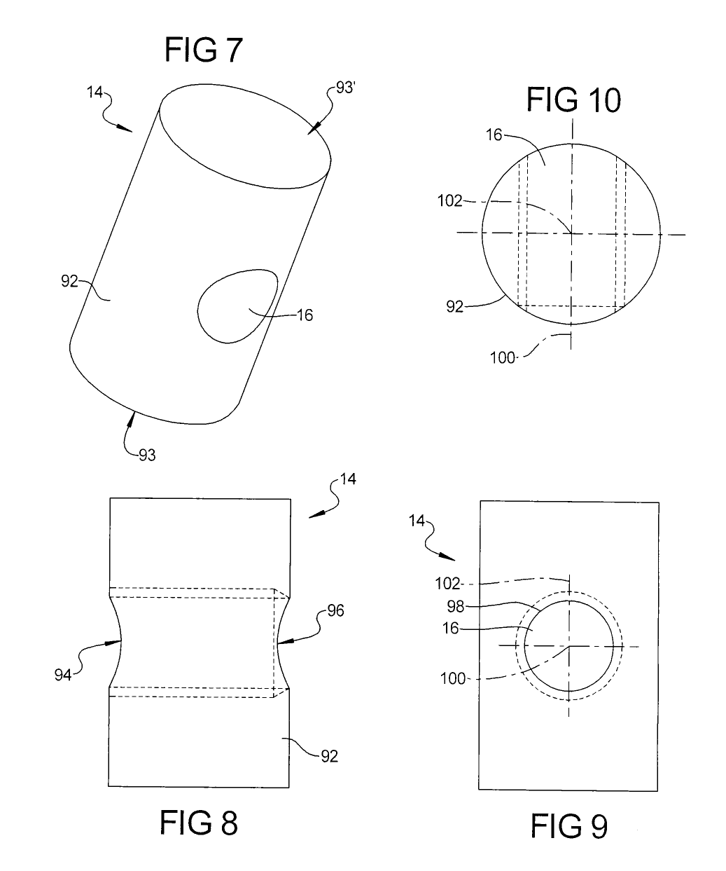

Referring to FIG. 7, hinge pin 14 can be created from a tubular or circular-rod shaped body 92 having threaded aperture 16 transversely oriented with respect to body 92. Opposed end faces 93, 93′ are substantially planar in shape and are also transversely oriented with respect to body 92.

Referring to FIG. 8, first and second recesses 94, 96 are created during the manufacturing (e.g., casting, forging, or molding) process or by subsequent removal of material when creating threaded aperture 16. First and second recesses 94, 96 result from the circular shape of body 92.

Referring to FIG. 9, an internal thread 98 of threaded aperture 16 is coaxially aligned on an aperture longitudinal axis 100 of threaded aperture 16. Aperture longitudinal axis 100 is oriented substantially transverse to a hinge pin longitudinal axis 102.

Referring to FIG. 10, the transverse relationship of aperture longitudinal axis 100 with respect to hinge pin longitudinal axis 102 is more clearly visible from the end view shown.

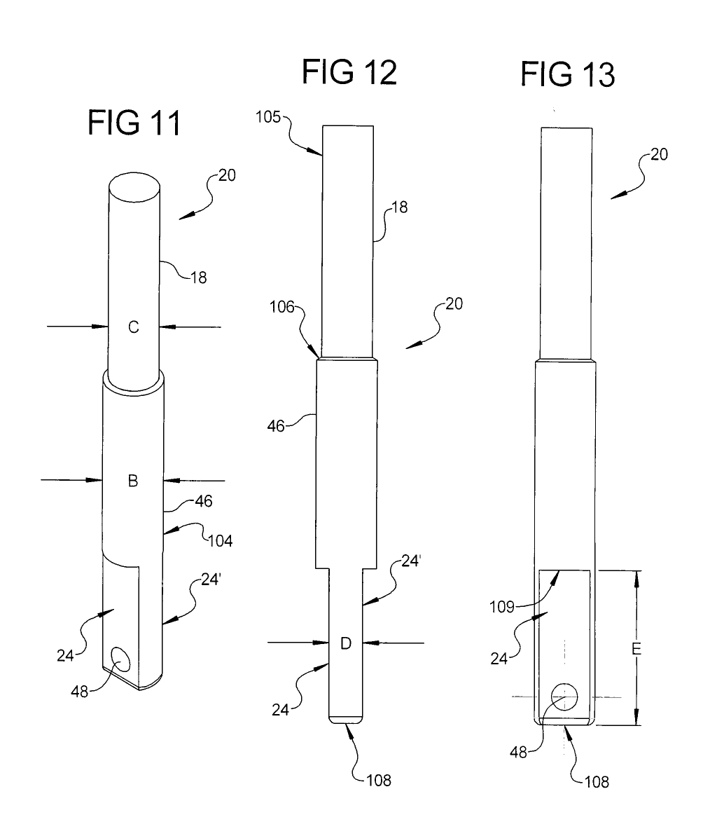

Referring to FIG. 11, clamp rod 20 can be provided with different diameters between un-threaded rod portion 46 and threaded portion 18. According to several embodiments, a rod diameter “B” of un-threaded rod portion 46 is greater than or equal to a thread diameter “C” of threaded portion 18. An arc surface 104 is therefore created by the rod diameter “B” of un-threaded rod portion 46 between the washer engagement flats 24, 24′.

Referring to FIG. 12, a transition portion 106 can be provided between threaded portion 18 and un-threaded rod portion 46. The location of transition portion 106 can be varied at the discretion of the manufacturer with respect to a free end 108 by varying a length of threaded portion 18. With further reference to both FIG. 12 and FIG. 6, a flat spacing “D” is provided between washer engagement flats 24, 24′ having flat spacing “D” being less than the cavity width “A” between first and second cam arms 34, 36 of latch handle 12 such that washer engagement flats 24, 24′ can be slidably received within washer arm spacing cavity 58.

Referring to FIG. 13 and again to FIG. 2, each of the washer engagement flats 24, 24′ have a flat length “E” measured with respect to free end 108. Flat length “E” provides clearance between pin receiving bore 48 and a flat end face 109 of each of the washer engagement flats 24, 24′ so that clearance is provided for rotation of first and second washer arms 54, 56 of pivot washer 26.

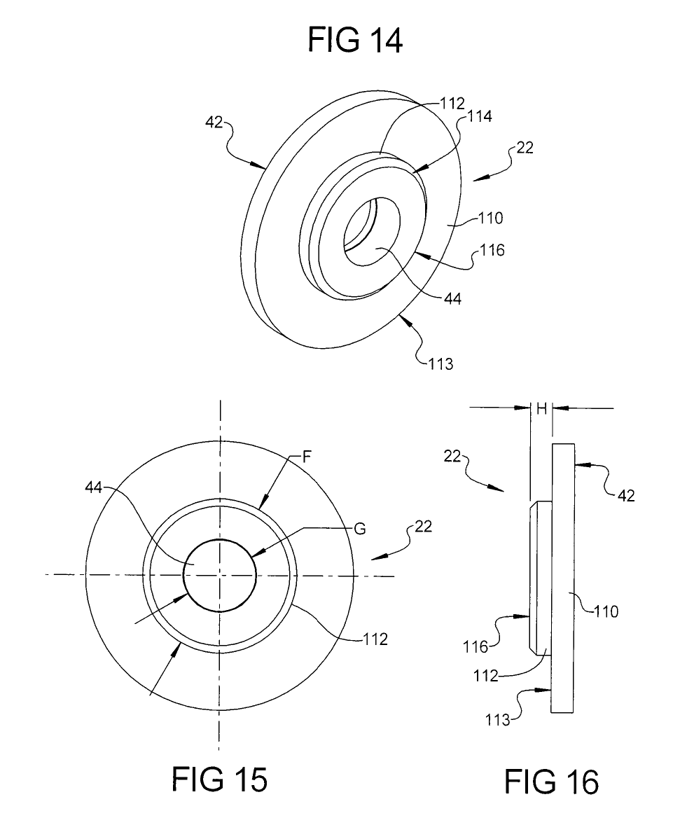

Referring to FIG. 14, clamp washer 22 provides a substantially circular clamp washer body 110 having a raised body portion 112 extending from a washer body face 113, which is oppositely directed with respect to cam portion contact surface 42. A chamfer 114 can be created at the transition between raised body portion 112 and a raised body face 116. The purpose for chamfer 114 will be further described with reference to FIGS. 21 through 24.

Referring to FIG. 15, raised body portion 112 has a raised body diameter “F” which is larger than a clearance bore diameter “G” of clamp rod clearance bore 44. Clamp rod clearance bore 44 extends through each of raised body portion 112 and clamp washer body 110. Raised body portion 112 is also concentrically formed with respect to clamp rod clearance bore 44.

Referring to FIG. 16, a raised body portion thickness “H” of raised body portion 112 is measured from washer body face 113. Raised body portion thickness “H” provides for an extension of raised body portion 112 within an aperture of a flange to be further described in reference to FIGS. 21 through 24.

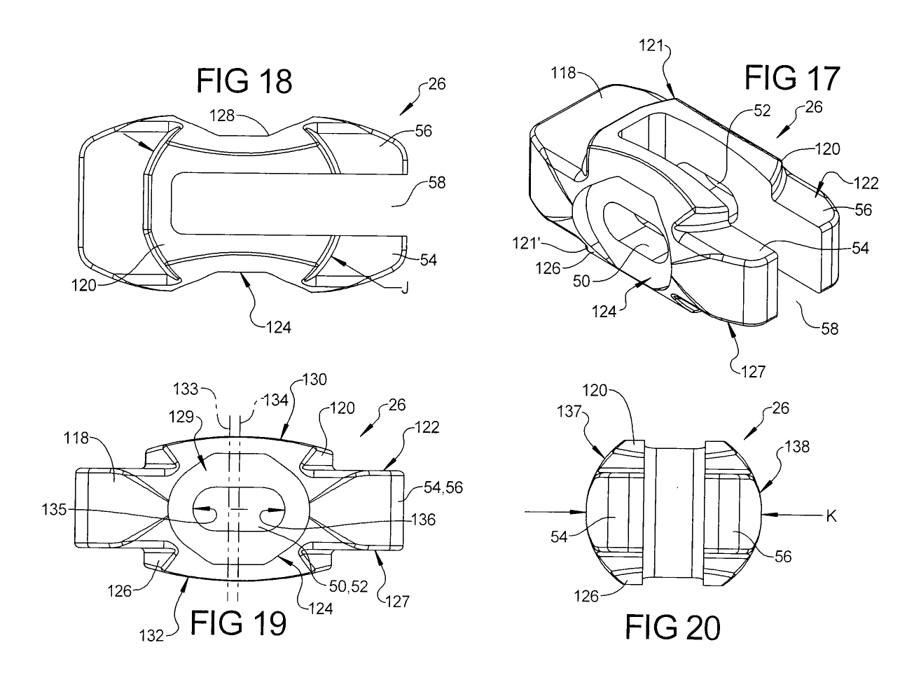

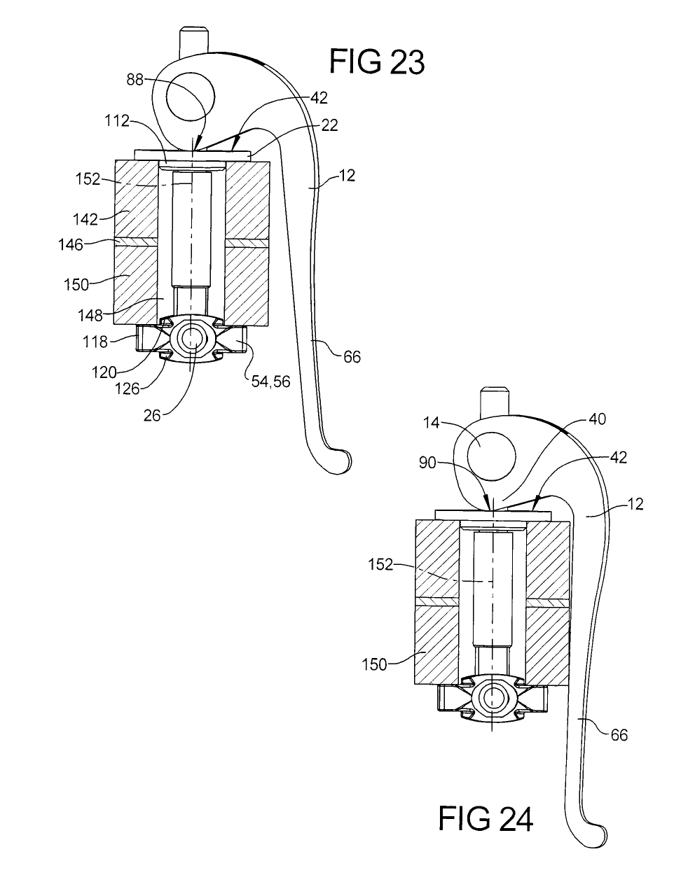

Referring to FIG. 17, pivot washer 26 has first and second washer arms 54, 56 homogeneously extending from a connecting end 118. A first pivot washer raised portion 120 extends away from a first planar surface 122 of connecting end 118, as well as both first and second washer arms 54, 56. A first arm recess 124 created in first washer arm 54 provides access to first elongated aperture 50 and provides a flattened surface to receive the pin head 60 of connecting pin 28, shown and described with reference to FIG. 2. A second pivot washer raised portion 126 is oppositely positioned from first pivot washer raised portion 120 and extends away from a second planar surface 127 which is oppositely oriented with respect to first planar surface 122, both of which are created in each of the first and second washer arms 54, 56 and connecting end 118. Rounded surfaces 121, 121′ are also created in first and second raised portions 120, 126 whose function will be described in better detail in reference to FIGS. 22 and 23.

Referring to FIG. 18, a second arm recess 128 created in second washer arm 56 is oriented in a mirror image configuration of first arm recess 124. Second arm recess 128 therefore provides similar access to second elongated aperture 52.

Referring to FIG. 19 and again to FIGS. 2 and 17, a substantially flat fastener sliding surface 129 is created during the manufacturing process or subsequently by removal of material of first arm recess 124 which allows the connecting pin 28 to slide within first elongated aperture 50. A similar and oppositely facing fastener sliding surface (not visible in this view) is created at second arm recess 128 shown and described with reference to FIG. 18. First pivot washer raised portion 120 includes a first convex surface 130 and second pivot washer raised portion 126 includes an oppositely directed second convex surface 132. A center-of-mass 133 of pivot washer 26 is positioned closer to connecting end 118 with respect to a central axis 134 because of additional mass of connecting end 118, which does not incorporate washer arm spacing cavity 58. Both first and second elongated apertures 50, 52 are centrally disposed with respect to central axis 134 of pivot washer 26. Also, as evident from FIG. 19, both first and second washer arms 54, 56 extend an equal distance (to the right as viewed in FIG. 19) with respect to central axis 134, as connecting end 118 oppositely and equally extends with respect to central axis 134 (to the left of central axis 134 as viewed in FIG. 19).

Referring to FIG. 20, a first outer semi-spherical surface 137 is defined between first and second pivot washer raised portions 120, 126 including portions of both connecting end 118 and first washer arm 54. A second outer semi-spherical surface 138 is oppositely directed with respect to first outer semi-spherical surface 137 which includes portions of first and second pivot washer raised portion 120, 126 and second washer arm 56. First and second outer semi-spherical surfaces 137, 138 together define a pivot washer body diameter “J.”

An exemplary installation of cam-bolt assembly 10 is shown in FIGS. 21 through 24 as follows. With specific reference to FIG. 21 and again to FIGS. 2 and 19, cam-bolt assembly 10 is shown in a release or pre-engaged position having latch handle 12 oriented substantially vertically upward as shown. Pin shaft 62 of connecting pin 28 is in contact with elongated aperture second end 136 of first and second elongated apertures 50, 52. The release cam location 84 of cam portion 40 is in contact with cam portion contact surface 42 of clamp washer body 110. The washer body face 113 of clamp washer body 110 is positioned in contact with an outer flange surface 140 of a first flange body 142 and chamfer 114 of raised body portion 112 assists with alignment and entry of raised body portion 112 into first fastener aperture 144. In this position, the raised body portion 112 of clamp washer 22 extends into a first fastener aperture 144 of first flange body 142. The raised body diameter “F” of raised body portion 112 as described in reference to FIG. 15 is sized to slidably fit within first fastener aperture 144 while minimizing the horizontal movement of clamp rod 20.

Also, in the release position of cam-bolt assembly 10, the pivot washer 26 is gravity supported (longitudinally suspended) by connecting pin 28 in first and second elongated apertures 50, 52 permitting the pivot washer 26 to hang vertically from clamp rod 20. This permits both the clamp rod 20 and pivot washer 26 to be received in first fastener aperture 144 as well as through a similar aperture created in a seal 146 and a coaxially aligned second fastener aperture 148 in a second flange body 150. The diameter of raised body portion 112 closely matching a diameter of first fastener aperture 144 positions a clamp rod longitudinal axis 152 of clamp rod 20 substantially coaxial with a longitudinal axis of first and second fastener apertures 144, 148. According to several embodiments, seal 146 can be a gasket such as a compressible rubber or similar gasket material. In the release position, pivot washer 26 is coaxially aligned with clamp rod longitudinal axis 152 of clamp rod 20 such that the pivot washer body diameter “J” is slidably received in each of the first and second fastener apertures 144, 148 as well as through the aperture formed in seal 146.

Referring to FIG. 22, in a next operation the installer manually rotates pivot washer 26 about connecting pin 28 (clockwise as viewed in FIG. 22). The installer threadably engages threaded portion 18 of clamp rod 20 into hinge pin 14 in a threaded engagement direction “K” or oppositely in a thread disengagement direction “L” until a first end face 154 of first and second washer arms 54, 56 slidably clears an aperture wall corner 156 of second fastener aperture 148. The installer can also oppositely (counterclockwise as viewed in FIG. 22) rotate pivot washer 26 at his or her discretion until first end face 154 slidably clears an opposite aperture wall corner 156′. A second end face 158 of connecting end 118 is not rotatated through these positions due to contact between connecting end 118 and clamp rod 20. Sliding clearance of first end face 154 with respect to aperture wall corner 156 or 156′ provides indication to the installer that the clamp rod 20 and pivot washer 26 are properly extended for subsequent engagement with second flange body 150.

With continuing reference to FIGS. 22 and 23 and again to FIGS. 2 and 19, once pivot washer 26 has been rotated to an orientation which is substantially transverse with respect to clamp rod longitudinal axis 152, the pivot washer 26 is moved horizontally (transverse to clamp rod longitudinal axis 152) until connecting pin 28 contacts first end 135 of first and second elongated apertures 50, 52 which positions connecting pin 28 out of alignment with central axis 133 of pivot washer 26. This off-center condition of connecting pin 28 positions center-of-mass 133 of the pivot washer 26 to the right of pin shaft 62 (as viewed in FIG. 19), allowing the moment arm of first and second washer arms 54, 56 to overcome the moment arm of connecting end 118, temporarily retaining the rotated (horizontal) position of pivot washer 26 with respect to clamp rod longitudinal axis 152. At this horizontally rotated position, either the first or second washer raised portion 120, 126 is aligned to subsequently extend into second fastener aperture 148. The first and second pivot washer raised portions 120, 126 provide a similar function as provided by raised body portion 112 of clamp washer 22. After the horizontal position of pivot washer 26 is reached, latch handle 12 is rotated approximately 180 degrees from the release position shown in FIG. 22 to reach a fully engaged position as shown in FIG. 23.

In the fully engaged position shown in FIG. 23, the maximum camming location 88 of cam portion 40 contacts the cam portion contact surface 42 of clamp washer 22. Maximum compression force is therefore generated by cam-bolt assembly 10 to releasably connect first and second flange bodies 142, 150 while partially compressing and/or sealingly engaging seal 146. In the maximum engaged position, handle arm 66 is free from (spaced away from) and does not contact either first or second flange body 142, 150.

Referring to FIG. 24, from the fully engaged position shown with respect to FIG. 23 the handle arm 66 of latch handle 12 is further rotated until handle arm 66 contacts second flange body 150. At this time, over-center camming location 90 of cam portion 40 is in contact with cam portion contact surface 42 of clamp washer 22. Over-center camming location 90 is offset with respect to clamp rod longitudinal axis 152 therefore providing an over-center position of engagement with over-center camming location 90 which tends to prevent the release of latch handle 12 until the release of cam-bolt assembly 10 is actuated by the installer. The steps of the above operations can be reversed to release the camming force of cam-bolt assembly 10.

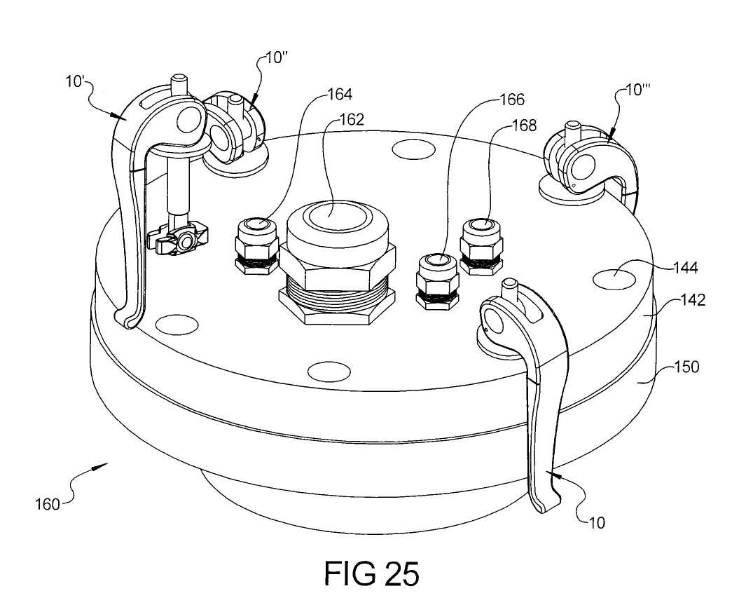

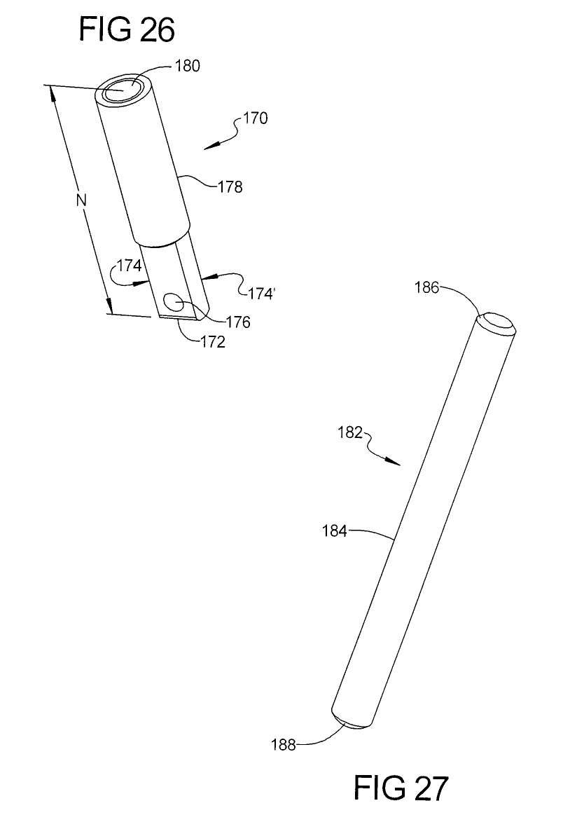

Referring to FIG. 25, cam-bolt assemblies 10 of the present disclosure can be used to replace a greater number of common fasteners normally used to install flanges having multiple fastener apertures. For example, as shown in FIG. 25, first flange body 142 includes eight fastener apertures, however, four cam-bolt assemblies 10 of the present disclosure can be used to provide clamping force. In a flange assembly 160 shown, the cam-bolt assemblies 10 are equally spaced at every other-one of the fastener apertures to evenly provide compression force to the flanges. In a typical installation, first flange body 142 can include a fluid discharge port 162 and a vacuum system connector 164. Also included can be a pressurized fluid inlet connector 166 and a pressurized fluid outlet connector 168.

With further reference to FIGS. 21-24 and again to FIG. 17, it will be evident that the first and second flange bodies 142, 150 can be oriented 90 degrees from the horizontal position shown and cam-bolt assemblies 10 of the present disclosure can still be used. In this orientation of the first and second flange bodies 142, 150, by originally manually orienting the pivot washer 26 coaxial with clamp rod longitudinal axis 152 of clamp rod 20, when pivot washer 26 extends beyond the aperture wall corner 156 of second fastener aperture 148 of second flange body 150, pivot washer 26 will self-rotate to an orientation transverse to clamp rod longitudinal axis 152, thus automatically transversely orienting pivot washer 26 for engagement with second flange body 150 when latch handle 12 is subsequently rotated. Rounded surfaces 121, 121′ of first and second raised portions 120, 126 of pivot washer 26 help to self-align first or second raised portions 120, 126 with second fastener aperture 148 of second flange body 150 as latch handle 12 is rotated to the fully engaged position.

Cam-bolt assemblies 10 of the present disclosure provide several advantages. The pivot washer 26 connected using a connecting pin 28 through first and second elongated apertures 50, 52 allows the pivot washer 26 to be rotated in either a clockwise or a counterclockwise direction for ease of installation. By providing raised portions on the pivot washer, the raised portions act to self-align the pivot washer with the apertures of the flanges. Also, the pivot washer body diameter selected for the application is intended to be slidably fit through the flange apertures while the length of the first and second washer arms 54, 56 and connecting end 118 provide engagement faces for contact between the pivot washer 26 and one of the flanges. By threadably engaging the clamp rod 20 to the hinge pin 14, the installer is able to rotate the pivot washer to slidably clear the aperture wall corner 156 of the second flange providing indication to the installer of the correct length for proper compression engagement of the cam-bolt assembly 10. The pivot washer 26 is also moved to an off-center position with respect to rod longitudinal axis 152 of the clamp rod 20 after the clamp rod 20 and pivot washer 26 are fully inserted through the apertures of the flanges. This positions first or second raised portions 120, 126 of pivot washer 26 to be slidably received within the aperture of the second flange body 150. Raised body portion 112 of clamp washer 22 and first and second raised portions 120, 126 of pivot washer 26 promote coaxial alignment of the clamp rod longitudinal axis 152 of clamp rod 20 with longitudinal axes of the first and second flange bodies 142, 150.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A cam-bolt assembly, comprising:
a latch handle having a cam portion including spatially separated first and second cam arms;
a hinge pin slidably disposed through a hinge pin aperture created in both the first and second cam arms, the hinge pin including a threaded aperture;
a clamp rod having at a first end a threaded portion threadably engaged with the threaded aperture of the hinge pin, and at a second end opposed washer engagement flats having a pin receiving bore created through and aligned perpendicular to the washer engagement flats; and
a pivot washer rotatably connected at the second end by a pivot pin received through the pin receiving bore, the pivot washer rotatable from a first position having the pivot washer coaxially aligned with a longitudinal axis of the clamp rod to a second position rotated ninety degrees from the first position, the pivot washer rotatable from the first position to the second position by rotation in either a clockwise or counterclockwise direction, the pivot washer being releasably retained in the second position by subsequent horizontal displacement in a direction transverse to the longitudinal axis of the clamp rod after rotation in either the clockwise or counterclockwise direction.

2. The cam-bolt assembly of claim 1, wherein the pivot washer further includes:
opposed parallel first and second washer arms individually rotatably contacting one of the washer engagement flats;
a connecting end having each of the first and second washer arms homogeneously connected to the connecting end; and
a first pivot washer raised portion extending away from a first planar surface of each of the first and second washer arms and the connecting end.

3. The cam-bolt assembly of claim 2, wherein the pivot washer further includes a second pivot washer raised portion extending away from a second planar surface of each of the first and second washer arms and the connecting end and oppositely directed with respect to the first pivot washer raised portion.

4. The cam-bolt assembly of claim 3, wherein both the first and second pivot washer raised portions define a raised portion diameter larger than a diameter of the clamp rod.

5. The cam-bolt assembly of claim 3, wherein both the first and second pivot washer raised portions and the first and second washer arms together define a pivot washer body diameter.

6. The cam-bolt assembly of claim 1, wherein the pivot washer further includes:
opposed parallel first and second washer arms individually rotatably contacting one of the washer engagement flats; and
an elongated aperture created in each of the first and second washer arms permitting the pivot pin to displace within the elongated aperture, the pivot washer releasably retained in the second position by subsequent horizontal displacement in a direction transverse to the longitudinal axis of the clamp rod having the pivot pin positioned toward either a first or a second end of the elongated aperture such that the pivot pin is positioned away from a central axis of the pivot washer.

7. The cam-bolt assembly of claim 6, wherein each of the first and second washer arms includes an arm recess creating a planar surface proximate to the elongated aperture of each of the washer arms.

8. The cam-bolt assembly of claim 1, wherein the pivot washer further includes:
opposed parallel first and second washer arms individually rotatably contacting one of the washer engagement flats; and
a connecting end having each of the first and second washer arms homogeneously connected to the connecting end.

9. The cam-bolt assembly of claim 1, wherein the pivot washer further includes an elongated aperture created in each of the first and second washer arms permitting the pivot pin to displace within the elongated aperture during horizontal displacement to the second position shifting a center-of-mass of the pivot washer in contact with the pivot pin away from a central axis of the pivot washer.

10. A cam-bolt assembly, comprising:
a latch handle having a cam portion including first and second cam arms separated by an arm spacing cavity;
a hinge pin slidably disposed through a hinge pin aperture created in both the first and second cam arms, the hinge pin including a threaded aperture;
a clamp rod having a first end connected to the hinge pin and a second end including opposed washer engagement flats having a pin receiving bore created therethrough; and
a pivot washer having spatially separated first and second washer arms each having an elongated aperture, the pivot washer rotatably connected at the second end of the clamp rod by a pivot pin received through the elongated apertures of the first and second washer arms and the pin receiving bore, the pivot washer rotatable from a first position having the pivot washer coaxially aligned with a longitudinal axis of the clamp rod to a second position rotated ninety degrees from the first position, the pivot washer rotatable from the first position to the second position in either a clockwise or a counterclockwise direction, the pivot washer releasably retained in the second position by subsequent horizontal displacement in a direction transverse to the longitudinal axis of the clamp rod having the pivot pin positioned toward either a first or a second end of the elongated aperture such that the pivot pin is positioned away from a central axis of the pivot washer.

11. The cam-bolt assembly of claim 10, wherein the pivot washer further includes a connecting end having each of the first and second washer arms homogeneously connected to the connecting end.

12. The cam-bolt assembly of claim 11, wherein the pivot washer further includes:
a first pivot washer raised portion extending away from a first planar surface of each of the first and second washer arms and the connecting end; and
a second pivot washer raised portion extending away from a second planar surface of each of the first and second washer arms and the connecting end and oppositely directed with respect to the first pivot washer raised portion, each of the first and second pivot washer raised portions defining a raised portion diameter.

13. The cam-bolt assembly of claim 12, further including a clamp washer slidably received on the clamp rod having a diameter larger than the raised portion diameter.

14. The cam-bolt assembly of claim 10, further including a clamp washer having:
a clamp rod receiving clearance bore to slidably receive the clamp rod;
a cam portion contact surface in contact with the cam portion;
a washer body face oppositely directed with respect to the cam portion contact face, the washer body face having a raised body portion extending therefrom.

15. The cam-bolt assembly of claim 14, wherein the cam portion further includes:
a release cam location in contact with the cam portion contact surface in a release position of the cam-bolt assembly;
a camming surface in sliding contact with the cam portion contact surface during rotation of the latch handle; and
a maximum camming location in contact with the cam portion contact surface defining a maximum engaged position of the cam-bolt assembly having the pivot washer at a closest position with respect to the cam portion, the maximum camming surface oriented one hundred eighty degrees from the release cam location.

16. The cam-bolt assembly of claim 14, wherein the cam portion includes an over-center camming location in contact with the cam portion contact surface, the over-center camming location displaced from a hinge pin axis oriented parallel to a handle arm of the latch handle.

17. The cam-bolt assembly of claim 10, wherein the first end of the clamp rod comprises a threaded end threadably engaged with the threaded aperture of the hinge pin to permit the clamp rod to be axially positioned with respect to the hinge pin.

18. The cam-bolt assembly of claim 10, further comprising a connecting member having a male threaded portion threadably connected to the threaded aperture of the hinge pin, and a female threaded portion threadably receiving a threaded first end of the clamp rod.

19. A cam-bolt assembly for connecting multiple flanges, comprising:
a clamp rod having a first end connected to a hinge pin and a second end including opposed washer engagement flats having a pin receiving bore created therethrough;
a pivot washer having a connecting end with spatially separated first and second washer arms each having an elongated aperture extending from the connecting end, the pivot washer rotatably connected at the second end of the clamp rod by a pivot pin received through the elongated apertures of the first and second washer arms and the pin receiving bore, the pivot washer rotatable from a first position having the pivot washer coaxially aligned with a longitudinal axis of the clamp rod to a second position rotated ninety degrees from the first position, the pivot washer rotatable from the first position to the second position in either a clockwise or a counterclockwise direction; and
at least one pivot washer raised portion extending away from a planar surface of each of the first and second washer arms and the connecting end, the at least one pivot washer raised portion defining a raised portion diameter;
when the pivot washer is rotated to the second position the at least one pivot washer raised portion is aligned within a fastener receiving aperture of one of the multiple flanges, the raised portion diameter defining a sliding fit within the fastener receiving aperture to minimize horizontal deflection of the clamp rod.

20. The cam-bolt assembly of claim 19, wherein the pivot washer is releasably retained in the second position by subsequent horizontal displacement in a direction transverse to the longitudinal axis of the clamp rod having the pivot pin positioned toward either a first or a second end of the elongated aperture such that the pivot pin is positioned away from alignment with respect to a central axis of the pivot washer

21. The cam-bolt assembly of claim 19, a latch handle having a cam portion including first and second cam arms separated by an arm spacing cavity, the hinge pin slidably disposed through a hinge pin aperture created in both the first and second cam arms.

22. The cam-bolt assembly of claim 19, wherein the clamp rod first end includes a threaded portion and the hinge pin includes a threaded aperture to threadably engage threaded portion.

23. The cam-bolt assembly of claim 19, wherein the at least one pivot washer raised portion comprises:
a first pivot washer raised portion extending away from a first planar surface of each of the first and second washer arms and the connecting end, the first pivot washer raised portion defining a first raised portion diameter; and
a second pivot washer raised portion extending away from a second planar surface of each of the first and second washer arms and the connecting end and oppositely directed with respect to the first pivot washer raised portion, each of the first and second pivot washer raised portions defining a second raised portion diameter substantially equal to the first raised portion diameter.

24. The cam-bolt assembly of claim 19, wherein in a release position of the cam-bolt assembly, the pivot washer is gravity supported by the connecting pin in the elongated apertures permitting the pivot washer to hang vertically downward from the clamp rod.

25. The cam-bolt assembly of claim 19, the pivot washer hanging vertically downward from the clamp rod permits both the clamp rod and the pivot washer to be received in a first fastener receiving aperture of a first one of the multiple flanges, through an aperture created in a seal abutting the first one of the multiple flanges, and further through a coaxially aligned second fastener aperture created in a second one of the multiple flanges oppositely positioned about the seal from the first one of the multiple flanges prior to the pivot washer being rotated to the second position.
